(19) United States
(12) Patent Application Publication
(10) Pub. No.: US 2026/0304274 A1
(43) Pub. Date: Oct. 1, 2026

(54) METHODS OF CONSIDERING SCELL CONDITIONS DURING CONDITIONAL MOBILITY

(71) Applicant: InterDigital Patent Holdings, Inc., Wilmington, DE (US)

(72) Inventors: Oumer Teyeb, Montreal (CA); Brian Martin, Farnham (GB); Paul Marinier, Brossard (CA); Martino Freda, Laval (CA); Keiichi Kubota, Setagaya-Ku (JP)

(73) Assignee: InterDigital Patent Holdings, Inc., Wilmington, DE (US)

(21) Appl. No.: 18/998,213

(22) PCT Filed: Aug. 4, 2023
(86) PCT No.: PCT/US2023/071679

§ 371 Date: Jan. 24, 2025

Related U.S. Application Data
(60) Provisional application No. 63/395,099, filed on Aug. 4, 2022.

(51) Int. Cl. H04W 36/30; H04W 36/00; H04W 36/08; H04W 36/36

(52) U.S. Cl. CPC H04W 36/302; H04W 36/0085; H04W 36/08; H04W 36/362

(57) ABSTRACT

A method for configuring a wireless transmit/receive unit (WTRU) is provided including receiving from a network one or more of a conditional handover (CHO) or a conditional primary secondary serving cell (PSCell) addition/change (CPAC) configurations including one or more triggering conditions. The triggering conditions may include a candidate primary cell (PCell) or PSCell and an associated signal level threshold. A set of candidate secondary cells (SCells) and associated signal level thresholds may be provided, along with a radio resource control (RRC) reconfiguration to be applied when the one or more triggering conditions are fulfilled. Upon fulfillment of the triggering conditions, the WTRU may execute the RRC reconfiguration and add the SCells that fulfill their corresponding thresholds. An indication may be sent to the network regarding SCells added.

### CROSS-REFERENCE TO RELATED APPLICATIONS

This application claims the benefit of U.S. Provisional Application No. 63/395,099, filed on Aug. 4, 2022, the entire contents of which are incorporated herein by reference.

### BACKGROUND

Rel16 NR introduced the concept of conditional handover (CHO) and conditional PSCell Addition/Change (CPA/CPC, or collectively referred to as CPAC), with an aim of reducing the likelihood of radio link failures (RLF) and handover failures (HOF).

Legacy LTE/NR handover can be triggered by measurement reports, even though there may not be anything preventing the network from sending a HO command to the wireless transmit receive unit (WTRU) even without receiving a measurement report. For example, the WTRU may be configure with an A3 event that triggers a measurement report to be sent when the radio signal level/quality (e.g., RSRP, RSRQ, etc.) of a neighbor cell becomes better than the Primary serving cell (PCell) and/or the Primary Secondary serving Cell (PSCell), for example, in the case of Dual Connectivity (DC). The WTRU may monitor the serving and neighbor cells and may send a measurement report when the conditions get fulfilled. When such a report is received, the network (e.g., current serving node/cell) may prepare a HO command (e.g., an RRC Reconfiguration message, with a reconfigurationWithSync) and send it to the WTRU. The WTRU may execute the HO, which will result in the WTRU connecting to the target cell.

### SUMMARY

A WTRU may be configured to consider the signal level of the candidate secondary cells (SCells) upon executing of a conditional handover (CHO). In embodiments, only candidate cells that have signal level above (typically, greater than) certain thresholds are added as SCells. In embodiments, a WTRU may be configured to consider the average signal level of the candidate cells (primary cell (PCell)+SCells, or just the SCells) to decide whether to execute the CHO. In embodiments, the CHO may be executed if the average signal level of all the candidate cells is greater than the average of the current serving cells by more than a certain threshold). In embodiments, a WTRU may be configured to add only a certain number of SCells that fulfill a certain threshold upon CHO execution. In embodiments, a WTRU may be configured to determine the SCell state (e.g., activated, deactivated, dormant) based on configured thresholds and the signal level of the SCell at the time of CHO execution. In embodiments, a WTRU may be configured to send indication to the network, upon the completion of the CHO execution, regarding added SCells, SCell state, and SCell measurement results

In embodiments, a method of configuring a WTRU may include receiving from a network a conditional handover (CHO) or a conditional primary secondary serving cell (PSCell) addition/change (CPAC) configuration having one or more triggering conditions. The triggering events may include one or more of a candidate primary cell (PCell) or PSCell and an associated signal level threshold. The configuration may include a set of candidate secondary cells (SCells) and associated signal level thresholds, and a radio resource control (RRC) reconfiguration to be applied when the one or more triggering conditions are fulfilled. The WTRU monitors the triggering conditions for the conditional reconfiguration and, upon fulfillment of the triggering conditions, executes the. The WTRU may further add the SCells that fulfill their thresholds and then send an indication to the network regarding the added SCells.

A WTRU may perform a method or be configured to receive measurement configuration information from a network device that indicates a list of cells to be measured. The list of cells may include a serving primary cell (PCell), one or more serving secondary cells (SCells), a candidate PCell, and one or more candidate SCells. The configuration information may also include a first triggering condition related to at least one of the serving PCell or the candidate PCell. The configuration information may further include a second triggering condition related to at least one of the one or more serving SCells or the one or more candidate SCells. The measurement of the signals associated with the list of cells and determines whether the first and second triggering conditions are satisfied. If the triggering conditions are satisfied, the WTRU may further determine whether the measurement configuration information is associated with a conditional handover (CHO). If the measurement is not associated with the CHO, the WTRU sends a layer 1 (L1) or a layer 3 (L3) measurement report. If the measurement event is associate with the CHO, the WTRU executes the CHO to the candidate PCell.

In embodiments, the measurement configuration information may include a specific indication of whether it is associated with a measurement reporting configuration or a CHO configuration. The WTRU may also determine that the first triggering condition is satisfied when a signal quality measurement of the candidate PCell exceeds a first signal quality threshold and that the second triggering condition is satisfied when a signal quality measurement of at least one of the candidate SCells exceeds a second signal quality threshold. The WTRU may determine that the second triggering condition is satisfied when an average signal quality of the one or more candidate SCells exceeds a signal quality threshold.

In embodiments, the measurement configuration information may include an indication of a signal quality threshold for one or more of the candidate SCells and the WTRU may apply an SCell configuration for the candidate SCells with a signal quality measurement that exceeds the signal quality threshold. Further, the WTRU may be configured to determine a state for each of the candidate SCells with the signal quality measurement that exceeds the signal quality threshold. In doing so, the state of the candidate SCells may be either in an active state, an inactive state, or a dormant state. The signal quality measurement may also exceed the signal quality threshold based on a maximum number of SCells that can be configured by the WTRU. In embodiments, a plurality of the candidate SCells may be associated with the same frequency. The WTRU then applies an SCell configuration for an SCell with the highest signal quality measurement of the plurality of SCells that are associated with the same frequency. The WTRU may send a CHO complete message upon the execution of the CHO to the candidate PCell.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a handover scenario in new radio (NR).

FIG. 3 illustrates an example of a conditional handover configuration and execution.

FIG. 4 illustrates an example of Layer 1 (L1)/Layer 2 (L2) inter-cell mobility operation using carrier aggregation (CA)

FIG. 5 illustrates an example of L1/L2 inter-cell mobility that is deployed only in certain areas.

FIG. 6 illustrates an example procedure performed by a WRTU in response to receiving measurement event configuration information.

### DETAILED DESCRIPTION

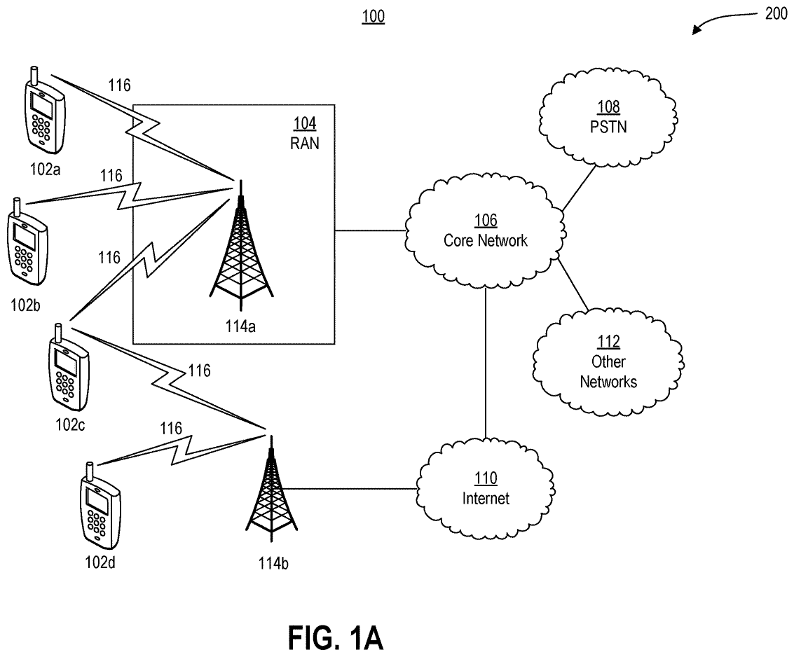

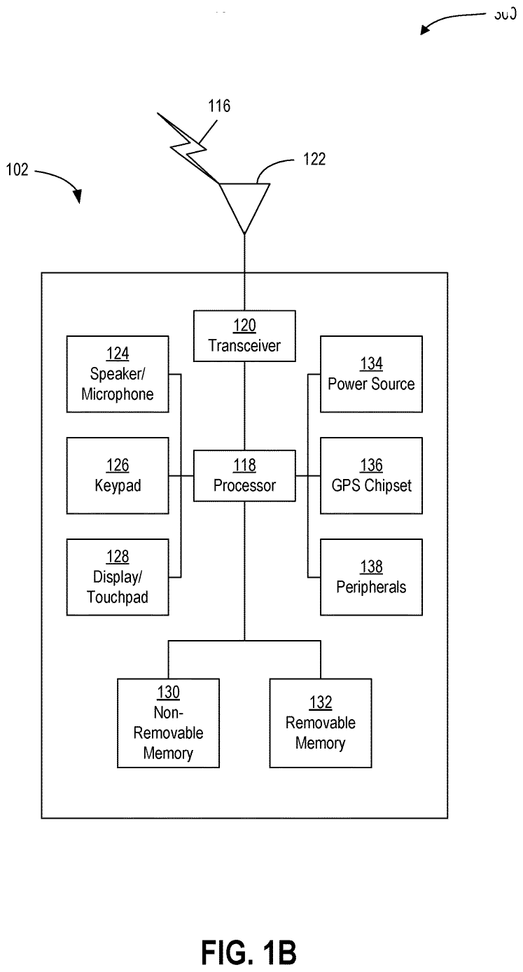

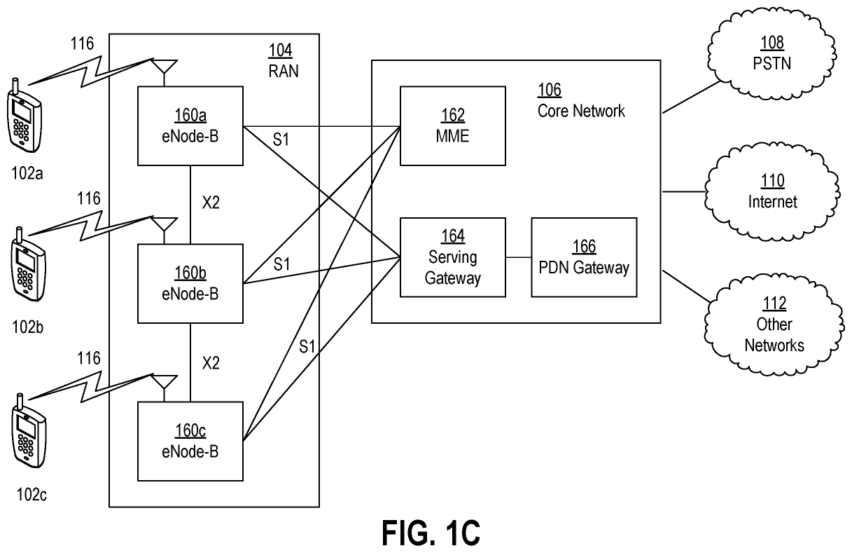

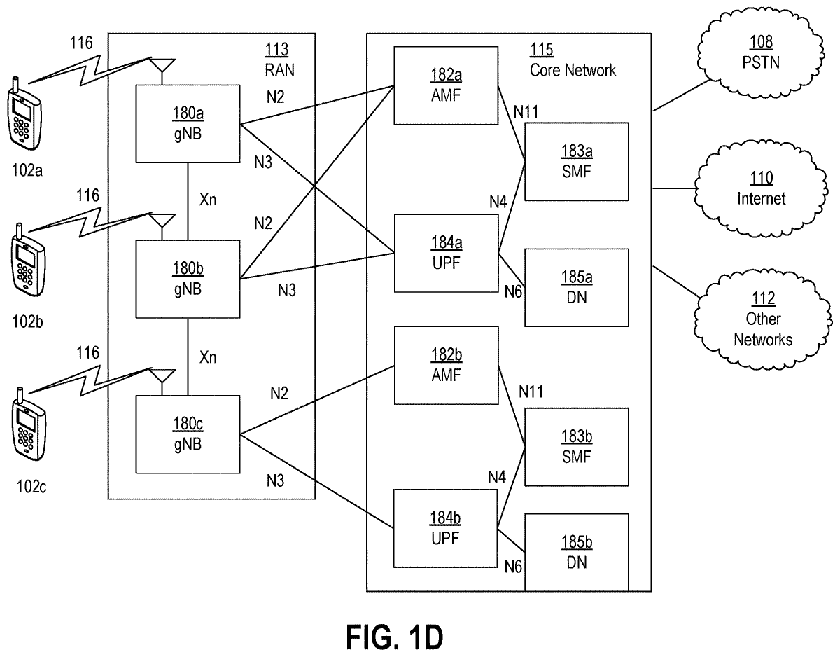

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above (greater than) a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

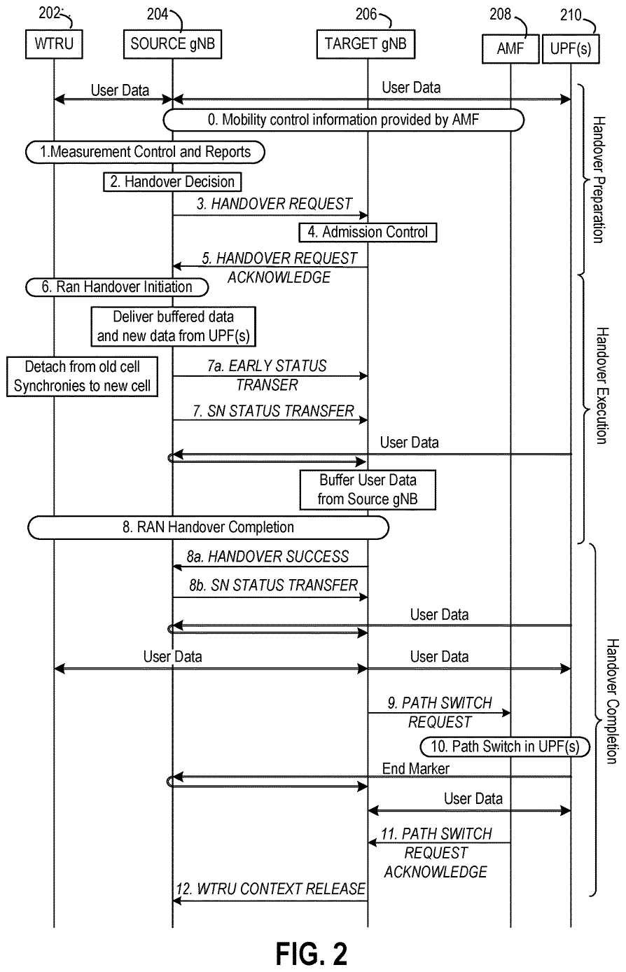

FIG. 2 depicts an example handover scenario in new radio (NR). At step 0, context of a WTRU within the source gNB 204 may be provided by an Access and Mobility Management Function (AMF). The WTRU context may include information regarding roaming and access restrictions, which were provided either at connection establishment or at the last timing advance (TA) update. At step 1, the source gNB 204 configures the WTRU measurement procedures and the WTRU 202 reports according to the measurement configuration. The source gNB 204 may decide to handover the WTRU 202, based on the received measurements, at step 2.

At step 3, the source gNB 204 then issues a Handover Request message to the target gNB 206, for example, by passing a transparent radio resource control (RRC) container with necessary information to prepare the handover at the target side. The information may include, at least, target cell ID, KgNB, C-RNTI (radio link identifier) of the WTRU 202 in the source gNB 204, radio resource management (RRM) configuration including WTRU inactive time, basic AS-configuration including antenna Info and/or DL Carrier Frequency, current QoS flow to data radio bearer (DRB) mapping rules applied to the WTRU 202, SIB1 from source gNB 204, the WTRU capabilities for different RATs, and/or PDU session related information. Further in some examples, the information may further include WTRU reported measurement information including beam-related information, if available. Thereafter, Admission Control may be performed by the target gNB 206, at step 4. Further, if the WTRU 202 is admitted, the target gNB 206 prepares the handover with L1/L2 and sends the HANDOVER REQUEST ACKNOWLEDGE to the source gNB 204 at step 5, which may include a transparent container to be sent to the WTRU 202 as an RRC message to perform the handover.

Once the HANDOVER REQUEST ACKNOWLEDGE has been deliver, handover execution begins, such that the WTRU 202 may detach from the old cell and synchronize to the new cell. In step 6, the source gNB 202 triggers the Uu handover by sending an RRCReconfiguration message to the WTRU 202, containing the information required to access the target cell, such as the target cell ID, the new C-RNTI, and/or the target gNB security algorithm identifiers for the selected security algorithms. The RRCReconfiguration message may also include any combination of a set of dedicated random access channel (RACH) resources, the association between RACH resources and synchronization signal blocks (SSBs), the association between RACH resources and WTRU-specific CSI reference signal (RS) configuration(s), common RACH resources, and system information of the target cell, etc. In some examples, the buffered data and new data are delivered from the UPF(s) 210.

As the detachment begins, the source gNB 204 sends the early transfer status transfer data and the SN STATUS TRANSFER message to the target gNB to convey the uplink PDCP SN receiver status and the downlink PDCP SN transmitter status of DRBs for which PDCP status preservation applies (e.g., for radio link control (RLC) AM) in step 7. The user data may be provided to the source gNB 202 and then to the target gNB 206. The WTRU 202 synchronizes to the target cell and completes the RRC handover procedure by sending RRCReconfigurationComplete message to target gNB 206 in step 8.

In the Handover Completion portion of the scenario, a HO success signal may be sent from the target gNB 206 to the source gNB 204, in step 8a, with the source gNB 204 providing an SN Status Transfer
step 8b. At step 9, the target gNB 206 sends a PATH SWITCH REQUEST message to AMF 208 to trigger 5GC to switch the DL data path towards the target gNB 206 and to establish an NG-C interface instance towards the target gNB 206. In this step 10, the 5GC switches the DL data path towards the target gNB 206.

The UPF 210 sends one or more “end marker” packets on the old path to the source gNB 202 per PDU session/tunnel and then may release any U-plane/TNL resources towards the source gNB 202. The AMF 208 confirms the PATH SWITCH REQUEST message with the PATH SWITCH REQUEST ACKNOWLEDGE message in step 11. Upon reception of the PATH SWITCH REQUEST ACKNOWLEDGE message from the AMF 208, the target gNB 206 sends the WTRU CONTEXT RELEASE to inform the source gNB 204 about the success of the handover. The source gNB 204 may then release radio and C-plane related resources associated to the WTRU context in step 12. Further, any ongoing data forwarding may continue.

NR Release 16 introduced the concept of conditional handover (CHO) and conditional primary secondary serving cell (PSCell) addition/change (CPA/CPC, or collectively referred to as CPAC), with the potential of reducing the likelihood of radio link failures (RLF) and handover failures (HOF).

Legacy LTE/NR handover may be typically triggered by measurement reports, even though there may be nothing preventing the network from sending an HO command to the WTRU even without receiving a measurement report. For example, the WTRU may be configure with an A3 event that triggers a measurement report to be sent when the radio signal level/quality (e.g., reference signal received power (RSRP), reference signal received quality (RSRQ), etc.) of a neighbor cell becomes greater than the primary serving cell (PCell), or also the PSCell in the case of DC. The WTRU monitors the serving and neighbor cells and may send a measurement report when conditions are fulfilled. When such a report is received, the network (e.g., current serving node/cell) may prepare the HO command. This HO command may be an RRC Reconfiguration message, with a reconfiguration WithSync that may be sent to the WTRU, which the WTRU executes immediately resulting in the WTRU connecting to the target cell.

CHO may differ from legacy handover. For example, multiple handover targets are prepared. Further, the WTRU may not immediately execute the CHO. The WTRU may be configured with triggering conditions, such as a set of radio conditions, and the WTRU may execute the handover towards one of the targets if the triggering conditions are fulfilled.

The CHO command may be sent when the radio conditions towards the current serving cells are still favorable, thereby reducing, among other things, the risk of failing to send the measurement report (for example, if the link quality to the current serving cell falls below (e.g., less than) acceptable levels when the measurement reports are triggered in normal handover) and the failure to receive the handover command (for example, if the link quality to the current serving cell falls below acceptable levels after the WTRU has sent the measurement report, but before it has received the HO command).

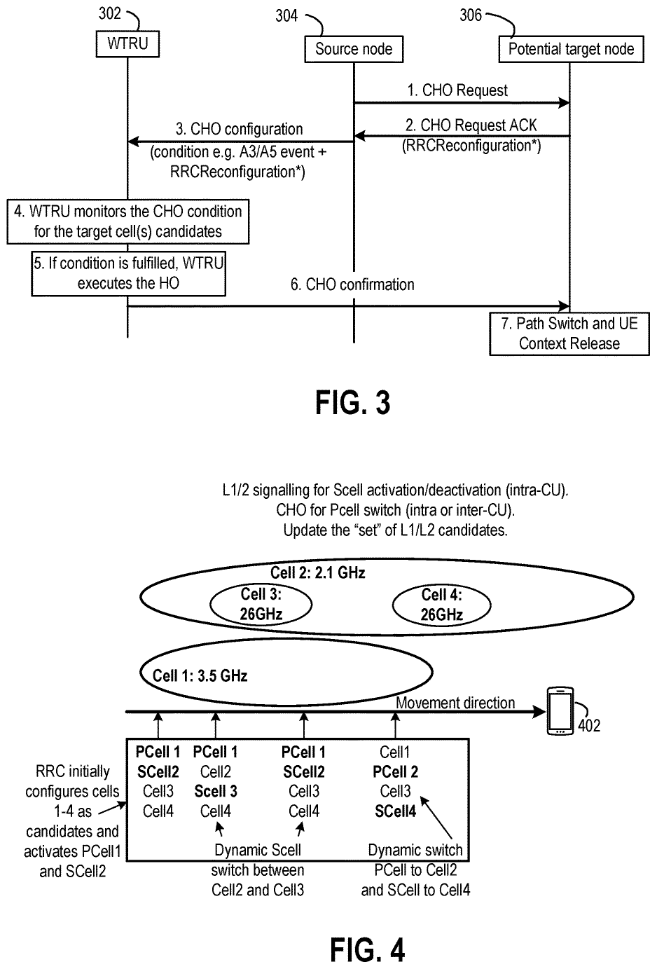

FIG. 3 illustrates an example of a conditional handover configuration and execution. As contemplated in FIG. 3, the triggering conditions for a CHO may include any combination of the following. In step 1, request may also be based on the radio quality of the serving cells/source node 304 and neighbor cells/potential target node 306, for example, the conditions that are used in legacy LTE/NR to trigger measurement reports. The CHO Request (e.g., from step 1) from the source node 304 to the potential target node 306 may result in a CHO request acknowledgement (e.g., RRCReconfiguration) in step 2.

In step 3, a WTRU 302 may be configured with a CHO that has an A3 (or A5) like triggering conditions and associated HO command. The WTRU 302 monitors the current and serving cells in step 4 for the target cell candidate(s). When the A3 (or, e.g., A5) triggering conditions are fulfilled, the WTRU may execute the associated HO command in step 6 (e.g., instead of or in addition to sending a measurement report). The WTRU 302 may switch its connection towards the target cell/target node 306. In step 7, the target node 306 may perform a path switch and/or release the context of the.

The CHO may help prevent unnecessary re-establishments in case of a radio link failure. For example, the WTRU may be configured with multiple CHO targets and the WTRU experiences an RLF before the triggering conditions with any of the targets gets fulfilled. Legacy operation may have resulted in RRC re-establishment procedure that may also have incurred considerable interruption time for the bearers of the WTRU. However, in the case of CHO, if the WTRU, after detecting an RLF, ends up a cell for which it has a CHO associated with (i.e., the target cell may be already prepared for it), the WTRU may execute the HO command associated with this target cell directly, instead of continuing with the full re-establishment procedure.

CPC and CPA may be extensions of CHO, but in DC scenarios. Further, a WTRU may be configured with triggering conditions for PSCell change or addition, and when the triggering conditions are fulfilled, it may execute the associated PSCell change or PSCell add commands.

The measurement configuration provided to the WTRU may include any combination of the following. The measurement configuration may include measurement objects, reporting configurations, measurement ID configurations, S-measure configuration, quantity configuration, and/or measurement gap configuration. Although the disclosure is primarily described in context of the measurement objects, reporting configurations and measurement ID configurations, the ideas may be applicable to a measurement configuration that includes any of the aforementioned configurations.

A measurement object may specify what the WTRU must measure and/or information regarding how the measurement may be performed. In embodiments, the information may include, for example, the RAT, frequency, sub-carrier spacing, SSB periodicity/offset/duration, reference signals and signal types to be measured, list of allowed/excluded neighbor cells of the concerned RAT/frequency to be measured, measurement gaps, offset that may be applied to prioritize/de-prioritize certain cells, etc.

The WTRU may be configured with multiple measurement objects, and the WTRU may have measurement configurations that may be related to different frequencies or even different RAT. The WTRU may be configured with up to 64 measurement objects, and each measurement object may be identified by a measurement object ID.

A reporting configuration may specify what is reported (e.g., reference signal type such as CSI-RS or SSB, the beam and cell level quantities to be reported such as RSRP/RSRQ, maximum number of cells or/and beams to be reported, etc.,) and/or the reporting criteria. In response to receiving a reporting configuration, the WTRU may send a measurement report or execute an associated HO configuration in the case of CHO. The reporting criteria may be the expiry of a periodic timer (e.g., periodic reporting configuration) or based on some radio conditions of serving and/or neighbor cells. The WTRU may be configured with up to 64 reporting configurations, and each reporting configuration may be identified by a reporting configuration ID.

A measurement object may be associated with one or more reporting configurations. This association may be made through a measurement ID. For example, the measurement ID configuration may be a list of the measurement ID, measurement object ID, and/or reporting configuration ID. As noted herein, the WTRU may be configured with up to 64 measurement IDs.

The WTRU may be configured with event triggered reporting through any of the following, including, but not limited to, Event A1, where the serving cell becomes greater than threshold; Event A2 where the serving becomes less than threshold; Event 3 where a neighbor becomes offset greater than SpCell, Event A4 where a neighbor becomes greater than threshold; Event A5 where SpCell becomes less than threshold1 and neighbor becomes greater than threshold2; Event A6 where a neighbor becomes offset greater than SCell; Event B1 where the inter RAT neighbor becomes greater than threshold; and/or Event B2 where PCell becomes less than threshold1 and inter RAT neighbor becomes greater than threshold2. The term SpCell may be used herein to refer to a PCell (Primary Cell), or in the case of DC, the Primary Secondary Cell (PSCell). Event A3, A5, B2 may be configured for (e.g., only configured for) the PCell or PSCell. However, it is contemplated that Events A1, A2, A3, A5, B2 may be configured for any serving cell. Event A6 may be configured for SCells (e.g., only for SCells, such as for the secondary cells in carrier aggregation (CA)). Events A4 and B1 may be related to neighbor cell measurements (e.g., and may not be related to any serving cell).

In the case of CHO, it is contemplated that, instead of sending a measurement report when the reporting conditions are fulfilled, the WTRU may execute an HO command. In the case of CHO, event triggered reporting configurations may be defined as including one or more of CondEvent A3 where the neighbor becomes offset greater than SpCell); CondEvent A4 where the neighbor becomes greater than threshold; CondEvent A5 where SpCell becomes less than threshold1 and neighbor becomes greater than threshold2.

A CHO configuration may contain a conditional reconfiguration ID, a conditional reconfiguration triggering condition, and/or an RRC reconfiguration to be executed when the conditions are fulfilled (e.g., a HO command). The triggering conditions may be a reference to 1 or 2 measurement IDs, and if 2 measurement IDs are specified, then the two generally refer to the same measurement object (e.g., one measID associating the measurement object related to the PCell with an A3 event and another measID associating the same measurement object with an A5 event). In Release 17, the WTRU may be configured with a maximum of 8 CHO configurations.

The WTRU typically maintains the PCell in an active state (e.g., WTRU continuously monitors the PDCCH of the PCell) while SCells and the PSCell may take states other than the active state. These other states may include a Deactivated/inactivated state, which may be a power saving state for the WTRU where the WTRU has the concerned SCells or PSCell configured but doesn't perform any active UL/DL transmission/reception via the concerned cell. In the case of the PSCell, the WTRU may perform some processing related to the PSCell, such as radio link monitoring and beam failure detection. Another state for the SCells and PCells may include a dormant state, which may be applicable only to SCells and may be considered as an intermediate state between the deactivated and the active state. It may be similar to the deactivated state in that the WTRU stops PDCCH monitoring on the concerned SCell, but it may be similar to the active state because the WTRU still perform CSI/CQI measurements and beam management on that SCell. Due to that, the network may be aware of the current channel state of the SCell and an SCell in a dormant state (e.g., or also referred to as an SCell in dormancy) may be quickly activated when the need arises (e.g., there may be a need for more data rate/capacity for a WTRU).

Within NR Release 17, inter-cell L1/L2 mobility may manage the beams in CA case, without cell change/add supported. In Release 18, one of the contemplated objectives may be to specify mechanisms and procedures of L1/L2 based inter-cell mobility for mobility latency reduction. In embodiments, mechanism and procedures of L1/L2 based inter-cell mobility for mobility latency reduction may be specified. Configuration and maintenance for multiple candidate cells may be specified to allow fast application of configurations for candidate cells (RAN2, RAN3). Dynamic switch mechanism among candidate serving cells (e.g., including special cell (SpCell) and SCell) for the potential applicable scenarios based on L1/L2 signaling (RAN2, RAN1) may also be provided. SpCell may refer to the PCell of the MSG or the PSCell of the secondary cell group (SCG) depending on whether the MAC entity is associated to the master cell group (MCG) or the SCG. L1 enhancements may be provided for inter-cell beam management, including L1 measurement and reporting, and beam indication (RAN1, RAN2). Early RAN2 involvement may be necessary, including the possibility of further clarifying the interaction with dynamic switching. Timing Advance management (RAN1, RAN2) and CU-DU interface signaling to support L1/L2 mobility, if needed (RAN3), may also be provided. FR2 specific enhancements may not precluded. Further, the procedure of L1/L2 based inter-cell mobility are applicable to various scenarios, such as standalone, CA and NR-DC case with serving cell change within one configured grant or cell group (CG), intra-DU case and intra-CU inter-DU case (applicable for Standalone and CA when no new RAN interfaces are expected), intra-frequency, inter-frequency, FR1, FR2, source and target cells being synchronized or non-synchronized, and inter-CU case not included.

L1/L2 based mobility was originally started in NR Release 17 and inter-cell beam management in Release 17 addresses intra-DU and intra-frequency scenarios. In this case the serving cell remains unchanged (i.e., with no possibility to change the serving cell using L1/L2 based mobility). In FR2 deployments, CA may typically be used in order to exploit the available bandwidth, for example, to aggregate multiple CCs in one band. These CCs are typically transmitted with the same analog beam pair (gNB beam and WTRU beam). The WTRU may be configured with TCI states (may have fairly large number, for example, 64) for reception of physical downlink control channel (PDCCH) and physical downlink shared channel (PDSCH). Each TCI state includes a RS or SSB that the WTRU refers to for setting its beam. For Release 17, the SSB may be associated with a non-serving PCI. MAC signaling (“TCI state indication for WTRU-specific PDCCH MAC control Element (CE)”) activates the TCI state for a Coreset/PDCCH. Reception of PDCCH from a non-serving cell may be supported by MAC CE indicating a TCI state associated to non-serving PCI. MAC signaling (“TCI States Activation/Deactivation for WTRU-specific PDSCH”) activates a subset of (up to) 8 TCI states for PDSCH reception. Downlink control information (DCI) indicates which of the 8 TCI states. Release 17 also supports “unified TCI state” with a different updating mechanism (DCI-based), but without multi-transmission/reception point (TRP). Release 18 may support unified TCI state with multi-TRP.

L1/L2 inter-cell mobility may be used to improve handover latency, with a conventional L3 handover or conditioned on the WTRU first sending a measurement report using RRC signalling. In response, the network may provide a further measurement configuration and potentially a CHO configuration. With a CHO the network provides a configuration for a target cell after the WTRU reports using RRC signalling that the cell meets a configured radio quality criteria. With conditional handover, to reduce the handover failure rate due to the delay in sending a measurement report then receiving an RRC reconfiguration the network provides, in advance, a target cell configuration as well as a measurement criteria that determines when the WTRU may trigger the CHO configuration. Both L3 methods, may result in some amount of delay due to the sending of measurement reports and receiving of target configurations, particularly in case of the conventional (non-conditional) handover.

L1/L2 based inter-cell mobility may allow a fast application of configurations for candidate cells, including dynamically switching between SCells and switching of the PCell (for example, switching the roles between SCell and PCell) without performing RRC signalling. The inter-CU case is not included in Release 18, as this requires relocation of the PDCP anchor and has already been excluded from the work item. An RRC based approach may be desired, such as to support inter-CU handover. L1/L2 may allow CA operation to be enabled instantaneously upon serving cell change.

FIG. 4 shows an example of L1/L2 inter-cell mobility operation using carrier aggregation (CA), whereby the candidate cell group may be configured by RRC and a dynamic switch of PCell and SCell may be achieved using L1/L2 signalling.

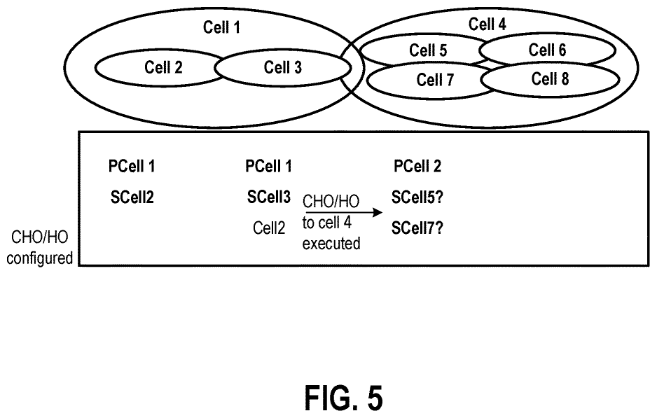

As discussed herein, Release 18 does not introduce support for inter-CU handover using L1/L2 signaling. Therefore, a conventional or conditional handover may be needed to cover at least this case. A conventional or conditional handover may be needed to support any mobility from with any specific L1/L2 mobility area to another. As shown in FIG. 5, L1/L2 inter-cell mobility may be deployed only in certain areas. Further, the network may divide its deployment into multiple L1/L2 mobility areas for other reasons, such as cell planning or due to limitation on the maximum number of cell configurations that may be simultaneously stored in the WTRU 402.

FIG. 5 shows a scenario where there are two gNBs, the first one serving cells 1 to 3, and the second one serving cells 4 to 8. The WTRU may be first in the first gNB and configured with a CHO configuration towards cell 4 of the second gNB. While in the coverage area of the first gNB, L1/L2 signalling may be used to add/remove or activate/deactivate different SCells. Although not shown in the figure, L1/L2 may be used to switch a PCell to an SCell, and vice versa.

The CHO trigger conditions may be based on events (e.g., condA3/A5) that are based on serving PCell and/or target PCell conditions. When the CHO conditions are fulfilled and the WTRU hands over to the second gNB, in some examples, it may not be possible to optimally decide the proper set of SCells to configure for the WTRU (e.g., as the triggering of the CHO may not consider the radio conditions of the candidate SCells). Additionally, if it is desired to make use of L1/L2 mobility in the candidate gNB, current mechanisms may force the network to (e.g., blindly) configure the possible cells (e.g., cells 5 to cell 8) as the candidate cells for L1/L2 mobility candidate cells. In embodiments, it may be desired to configure the CHO, so that the WTRU may choose not only the best candidate PCell, but also consider the conditions of serving SCells and candidate SCells.

The discussion below focuses primarily on the CHO case. However, embodiments may be applicable to the case of CPA or CPC (e.g., PSCell conditions instead of PCell conditions, and the SCells referring to the SCG SCells). Further, in the descriptions below it may be assumed that the L1/L2 mobility signalling contains an indication regarding the SCell being promoted to a PCell. The associated configuration/signalling may also be applicable to the case where a non-serving neighbor cell is also being promoted to a PCell. Further, in the discussion below, an L1/L2 signalling could refer to a MAC CE or a DCI. In addition, the term “a cell fulfils a threshold” is used to mean that the signal level of that cell may be above the signal level threshold associated with that cell. The terms “candidate” and “target” are also used interchangeably. It should be noted that embodiments may be applicable even without L1/L2 mobility (e.g., enhancements to legacy CHO operation).

The WTRU may be configured to perform CHO based on the signal level of one or more candidate SCells (e.g., individually). For example, the WTRU may be configured with a CHO configuration that contains a trigger condition on a particular candidate PCell, associated candidate SCells to be added as additional carriers upon the fulfilment of the CHO trigger conditions, and/or additional signal level threshold (e.g., RSRP threshold) regarding the SCells that the WTRU checks before adding the SCells.

In an embodiment, one signal level (e.g., RSRP) threshold may be configured for the candidate SCells. On executing the CHO and applying the CHO configuration upon the fulfilment of the CHO trigger conditions for the PCell, the WTRU may check the signal level of the candidate SCells and apply (e.g., only apply) the SCell configuration concerning those cells that have a signal level that satisfies the configured threshold.

In embodiments, a different signal level threshold may be configured for each candidate SCell. For example, the different signal quantity may be associated with the threshold of a given candidate SCell (e.g., SCell1 has an RSRQ threshold associated with it, SCell2 has an RSRP threshold associated with it, etc.).

The signal level threshold may be associated with a subset of the candidate SCells. In embodiments, for example, a list of cells (e.g., a list of PCIs) may be associated with a certain threshold. In embodiments, a certain threshold may be associated for cells of a given frequency or given range of frequencies. As another example, a certain set of the cells may have thresholds that may be related to RSRQ, while the others have thresholds related to RSRP.

The WTRU may be configured to apply the configuration of all the candidate SCells that fulfil their corresponding threshold. In embodiments, the WTRU may be configured to apply the configuration of for up to N (e.g., where N may be configured by the network or fixed in the 3GPP specifications) best candidate SCells that fulfil their corresponding threshold.

The WTRU may configured with different prioritization of the candidate SCells (e.g., based on frequency, or other network proprietary reason), and if more than N candidate SCells fulfil their corresponding threshold, the WTRU may order the candidate SCells according to their priorities and may apply the configuration of the top N of them (i.e., candidate SCellx that has a lower signal level than SCelly may end up being chosen, if SCellx has higher priority than SCelly and SCellx still fulfils its corresponding threshold).

The signal level of the PCell and candidate SCells may be considered together. In embodiments, the CHO execution condition may consider both the candidate PCell and candidate SCell(s) signal levels. For example, the triggering condition for CHO to a particular candidate PCell may be considered fulfilled if both (e.g., only if both) the candidate PCell and one or more candidate SCells meet the configured thresholds(s).

The CHO execution condition may consider an average measurement amongst more than one candidate cell. The triggering condition may be considered to have been met, for example, if one or more apply: (a) if the average signal level of all the candidate cells is above a threshold; (b) if the average signal level of all the candidate calls is greater than the average signal level of all the current serving cells by more than a certain threshold, (c) if the average of the N best candidate cells is above a threshold, (d) if the average of the N best candidate cells is greater than the average of the N best current serving cells by more than a certain threshold, and so on.

The PCell and/or candidate PCell may carry a greater weight than the SCells and candidate SCells during the averaging, for example, assuming that there are 3 serving SCells and 4 candidate SCells. The average for the serving cells may be calculated as:

$$f * rsrp\_PCell + ( 1 - f ) * ( rsrp\_SCell1 + rsrp\_SCell2 + rsrp\_SCell3 ) / 3 ,$$

while for the candidate cells it may be calculated as:

$$f * rsrp\_PCell + ( 1 - f ) * ( rsrp\_candidate \_SCell1 + rsrp\_candidate \_SCell2 + rsrp\_candidate \_SCell3 + rsrp\_candidate \_SCell4 ) / 4.$$

The scaling/weighting factors may be the same for all SCells or may be different for each SCell. The scaling/weighting factors may be configured by the network or may be predefined in the standard.

Embodiments, averaging may be performed for SCells (e.g., only for SCells), while the candidate PCell may be compared separately (e.g., with an absolute threshold or relative threshold as compared to the current PCell). Alternatively or additionally, averaging may be performed for candidate SCells. In some examples, the Candidate PCell may be compared to absolute threshold, and candidate SCells may be averaged and compared with an absolute threshold. The triggering condition for the CHO may be considered to be fulfilled if the candidate PCell is above a certain threshold and the average signal level of all the candidate SCells is above a certain threshold, and/or if the candidate PCell is above a certain threshold and the average signal level of the N best candidate SCells is above a certain threshold.

In some examples, the candidate PCell may be compared to absolute threshold and the candidate SCells averaged and may be compared with the average of current SCells, wherein the triggering condition for the CHO may be considered to be fulfilled if the candidate PCell is above a certain threshold and the average signal level of all the candidate SCells is greater than the average signal level of all the current serving SCells by more than a certain threshold and/or if the candidate PCell is above a certain threshold and the average signal level of the N best candidate SCells is greater than the average signal level of the N best current serving cells by a certain threshold.

In embodiments, the candidate PCell may be compared to current PCell, candidate SCells averaged compared with an absolute threshold the average of current SCells: The triggering condition for the CHO may be considered to be fulfilled if the candidate PCell is greater than the current PCell and the average signal level of all the candidate SCells is greater than a certain threshold and/or the candidate PCell has a certain threshold greater than the current PCell and the average signal level of all the N best candidate SCells is greater than a certain threshold.

In embodiments, the candidate PCell compared to current PCell, candidate SCells averaged and compared with the average of current SCells. For example, the triggering condition for the CHO may be considered to be fulfilled if the candidate PCell is a certain threshold greater than the current PCell and the average signal level of the N best candidate SCells is greater than the average signal level of all the current serving SCells by more than a certain threshold and/or if the candidate PCell is above the current PCell and the average signal level of the N best candidate SCells is greater than the average signal level of the N best current serving cells by a certain threshold.

In embodiments, the same measurement quantity (e.g., RSRP or RSRQ) and associated threshold may be configured for all the candidate SCells as well as the candidate PCell. For example, the same measurement quantity (e.g., RSRP or RSRQ) and associated threshold may be configured for all the candidate SCells, but different measurement quantity and associated threshold may be configured for the candidate PCell. The candidate SCells may be associated with different threshold or even different measurement quantity (e.g., RSRP or RSRQ). This may be different for each candidate SCell or may be the same for a certain set of the candidate SCells.

SCells to be added may be chosen based on relative comparison of the signal level of candidate SCells. For example, the WTRU may be configured with a CHO configuration that contains a trigger condition on a particular target PCell, associated SCells to be added as additional carriers. Further defined may be the maximum number of SCells that may be added upon the fulfilment of the CHO trigger conditions. For example, the WTRU may perform the following upon the fulfilment of the CHO trigger conditions (based on the target PCell): (a) identify the best candidate SCell in each frequency, (b) order these candidate SCells according to the signal quality, and/or (c) take the top m SCells (e.g., where m is equivalent to the configured maximum number of SCells) and apply their corresponding SCell configurations. A signal level threshold may be specified (e.g., in addition to the maximum number of SCells). For example, when configured this way the WTRU may perform the following upon the fulfilment of the CHO trigger conditions (e.g., based on the target PCell): (a) identify the best SCell candidate in each frequency that also satisfies the configured threshold (b) order these candidate SCells according to the signal quality, and/or (c) take the top m SCells (e.g., where m is equivalent to the configured maximum number of SCells), and apply the corresponding SCell configurations.

The signal level threshold may be the same for all the SCells. For example, the signal level threshold may be specified per each candidate SCell or per a given set of SCells. The signal level threshold may be specified per each carrier frequency or per a given set/range of carrier frequencies.

The WTRU may determine which SCell(s) to activate based on any combination of factors. For example, when the WTRU decides to apply a given SCell configuration upon the fulfilment of the CHO triggering condition and the SCell adding conditions discussed above, the WTRU may add the SCell in either an activated state, a deactivated state or a dormant state. In embodiments, the WTRU may be configured to determine the SCell state (e.g., active, inactive, dormant) based on signal level thresholds or maximum number of cells. In embodiments, two thresholds may be configured, where candidate SCells that have signal level above the first threshold are added as activated SCells, candidate SCells that have signal level between the first and the second threshold are added as dormant SCells, candidates that have signal level below/less than the second threshold are added as deactivated SCells. In embodiments, the WTRU may be configured with a maximum number of SCells to be added in activated state (e.g., n_activated), in deactivated state (e.g., n_deactivated) or/and dormant state (e.g., n_dormant), and the WTRU may add the best n_activated candidate cells as activated SCells, the next n_dormant best cells as dormant SCells, and the next n_deactivated best cells as deactivated SCells.

The conditions of thresholds and maximum numbers of cells may be combined. In embodiments, additional thresholds may be specified, if the signal level of the SCell is below the associated threshold, the SCell may not be added upon CHO execution. Further, in embodiments, as in the embodiments in the previous sections, the thresholds may be common for all frequencies/SCells or may be different for each frequency/SCell.

The WTRU may be configured to determine the candidate set list for L1/L2 mobility. For example, the WTRU may be configured to release the SCell configuration of the candidate cells that do not fulfil the SCell addition condition (e.g., for the embodiments above). The WTRU may be configured to store the SCell configuration of the candidate cells that do not fulfil the SCell addition condition (e.g., according to any of the embodiments above) and consider them as part of the L1/L2 mobility set. For example, the WTRU may anticipate a future L1/L2 mobility indication that may indicate a cell within the mobility set to become an SCell or even a PCell. In embodiments, a combination of the above two may be possible. In embodiments, the WTRU may be configured to add certain SCells (e.g., signal level above/greater than a certain threshold, the top n cells, etc.), keep the configuration of certain cells as part of the L1/L2 mobility set list (e.g., signal level between two thresholds, etc.), and release the configuration of certain cells (e.g., signal level below a certain threshold).

The WTRU may be configured with multiple L1/L2 mobility candidate set lists that may be applied upon execution of the CHO. Upon executing the CHO, the candidate set to be applied may depend on the outcome of the CHO evaluation. For example, in case the target PCell meets a conditional trigger condition, the set of SCells or L1/L2 candidate cells to be configured may depend on the result of SCell/target candidate cell measurements. In embodiments, the L1/L2 candidate set A (e.g., cell 1, 2, 3) may be applied if a target candidate cell 1 is greater than a candidate cell 4, while L1/L2 candidate set B (e.g., cell 4, 5, 6) may be applied if a target candidate cell 4 is greater than a candidate cell 1. The result of the comparison of cell 1 and cell 4 is an indicator of the region of the PCell that the WTRU has entered and, therefore, which candidate cells may be the most likely to be used. In embodiments, the WTRU may enter a PCell north-west then cells 1, 2, 3 are most likely and cell 1 has a greater measurement result than cell 4, while the WTRU enters a PCell north-east then cells 4, 5, 6 are most likely and cell 4 has a greater measurement result than cell 1).

The WTRU may send a response signal. For example, the WTRU may inform the network regarding the decision about the candidate SCells, which it has applied according to any of the embodiments above. Further, the WTRU may provide to the network one or more of the following: (a) the SCells that have been added (e.g., that their configuration has been applied), (b) the candidate SCells that have not been added, (c) the state of the SCells that have been added (e.g., activated, deactivated, dormant), (d) the candidate SCells that have been released, (e) the candidate SCells that have not been added but kept as part of the L1/L2 mobility set, and/or (f) the measurement result of the candidate/added/released SCells. Other information may be provided in addition to the above listing or separately. The content of the response may be based on whether the configuration information is associated with measurement reporting or a CHO. For example, as noted above, the reporting configuration may specify what is to be reported by the WTRU. If the reporting configuration specifies is associated with a measurement report, then the WTRU may send a measurement report. If the reporting configuration is associated with a CHO, the WTRU may execute a CHO to the candidate PCell.

The indication about the added SCells may be included in an RRC reconfiguration complete message. The information about the SCells may be sent in a separate message, such as, in another RRC message (e.g., either autonomously by the WTRU or on request from the network) or a MAC CE.

With reference to the discussion above, in embodiments, the WTRU may receive a CHO configuration that contains one or more of (i) a candidate PCell and associated signal level threshold (e.g., absolute or relative to current PCell) as a CHO triggering condition, (ii) a set of candidate SCells and associated signal level thresholds (e.g., one threshold for all, separate threshold for each, etc.,), and/or (iii) an RRC reconfiguration (e.g. HO command) to be applied when the CHO conditions are fulfilled. The WTRU may further monitor the CHO triggering condition. Upon the fulfilment of the CHO triggering conditions, the WTRU may execute the CHO, but only adding the SCells that fulfil their thresholds, and then send an indication to the network regarding SCells added and additional information, such as measurement of all the candidate/added SCells (e.g., in the RRC reconfiguration complete message, in a separate message, etc.).

The WTRU may receive a CHO configuration that contains one or more of the following: (a) a candidate PCell and set of SCells and associated average signal level threshold (e.g., absolute or relative to the serving cells) as the CHO triggering condition and/or (ii) an RRC reconfiguration (e.g., HO command) to be applied when the CHO conditions are fulfilled. The WTRU may monitor the CHO triggering condition and, upon the fulfilment of the CHO triggering conditions (e.g., average signal level of all the candidate cells is above the configured threshold, average signal level of all the candidate cells is greater than average signal level of all the current serving cells by more than the configured threshold, etc.), execute the CHO and send information to the network such as measurement of the candidate/added SCells (e.g., in the RRC reconfiguration complete message, in a separate message, etc.).

The WTRU may receive a CHO configuration that contains one or more of the following: (i) a candidate PCell and associated signal level threshold (e.g., absolute or relative to current PCell) as the CHO triggering condition, (ii) a set of candidate SCells and associated signal level threshold and maximum number of SCells (m) that can be added, and/or (iii) an RRC reconfiguration (e.g., HO command) to be applied when the CHO conditions are fulfilled. The WTRU may monitor the CHO triggering condition. Upon fulfilment of the CHO triggering conditions, the WTRU may execute the CHO (e.g., only adding up to the top m SCells that fulfil the SCell threshold). The WTRU may send an indication to the network regarding which SCells were added and/or additional information, such as measurement of the candidate/added SCells (e.g., in the RRC reconfiguration complete message, in a separate message, etc.).

The WTRU may receive a CHO configuration that contains one or more of the following: (i) a candidate PCell and associated signal level threshold (e.g., absolute or relative to current PCell) as the CHO triggering condition, (ii) a set of candidate SCells and associated signal level thresholds (e.g., thresh1, thresh2), and/or (iii) an RRC reconfiguration (e.g., HO command) to be applied when the CHO conditions are fulfilled. The WTRU may continue to monitor the CHO triggering condition. Upon the fulfilment of the CHO triggering conditions, the WTRU may execute the CHO, while setting the state of the SCells according to the following (a) if the signal level of the SCell is below thresh1, deactivate the SCell, (b) if the signal level of the SCell is between thresh1 and thresh2, set the SCell to dormancy, and/or (c) if the signal level of the SCell is above thresh2, activate the SCell. The WTRU then sends an indication to the network regarding the state of the SCells and additional information such as measurement of the candidate/added SCells (e.g., in the RRC reconfiguration complete message, in a separate message, etc.).

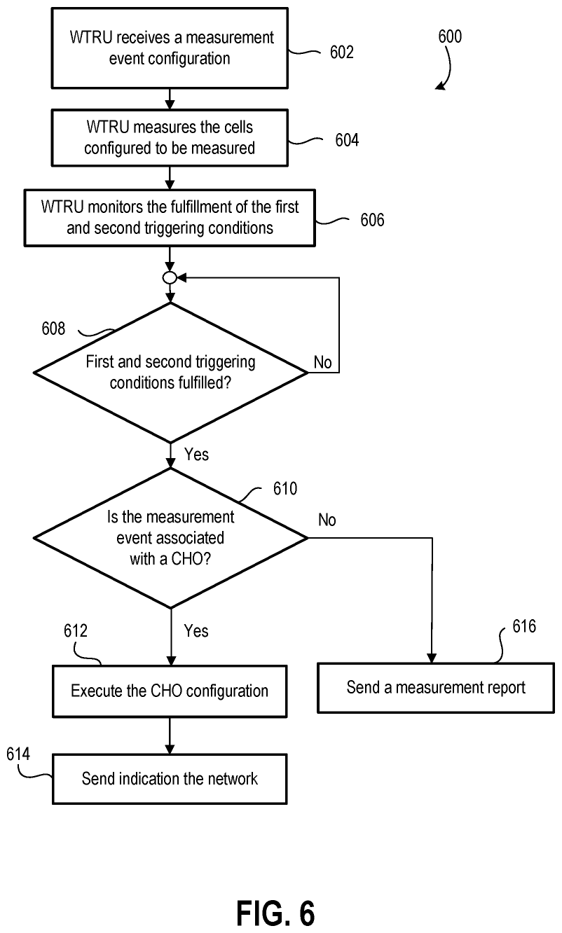

FIG. 6 illustrates an example procedure 600 performed by a WRTU in response to the reception of measurement event configuration information. At 602, the WTRU may be configured to receive measurement configuration information from a network device that indicates a list of cells to be measured. The list of cells may include a serving primary cell (PCell), one or more serving secondary cells (SCells), a candidate PCell, and one or more candidate SCells. The configuration information may also include a first triggering condition related to at least one of the serving PCell or the candidate PCell. The configuration information may further include a second triggering condition related to at least one of the one or more serving SCells or the one or more candidate SCells.

At 604, the WTRU measures the cells that are configured to be measured. The radio conditions to be measured for the source PCell, target PCell, one or more source SCells, and one or more target SCells may include, for example, one or more of the absolute/relative thresholds of the individual source/target PCell and source/target SCells, the absolute/relative thresholds of the average of the source PCell and SCells, and the target PCell and SCells. Other signal quality conditions may also be included.

At 606, the WTRU monitors the signals associated with the list of cells to determine whether the first and second triggering conditions are satisfied. At 608, the WTRU determines whether the first and second triggering conditions are satisfied. If the triggering conditions are not satisfied, the WTRU continues to monitor the cells configured to be measured at 608. If the triggering conditions are satisfied at 608, the WTRU determines whether the measurement configuration is associated with a conditional handover (CHO) at 610. If the measurement is not associated with the CHO at 610, the WTRU sends measurement report at 616, such as a layer 1 (L1) or a layer 3 (L3) measurement report. The report may include the measurement results of the service PCell/SCell, target PCell/SCells, or otherwise. If the measurement event is associate with the CHO at 610, the WTRU executes the CHO to the candidate PCell at 612. For example, at 614, the WTRU sends an indication to the network indicating the CHO. The message sent by the WTRU may be a HO complete message.

The measurement configuration information may include a specific indication of whether it is associated with a measurement reporting configuration or a CHO configuration. The WTRU may also determine that the first triggering condition is satisfied when a signal quality measurement of the candidate PCell exceeds a first signal quality threshold and that the second triggering condition is satisfied when a signal quality measurement of at least one of the candidate SCells exceeds a second signal quality threshold.

The WTRU may determine that the second triggering condition is satisfied when an average signal quality of the one or more candidate SCells exceeds a signal quality threshold.

The measurement configuration information may include an indication of a signal quality threshold for one or more of the candidate SCells and the WTRU may apply an SCell configuration for the candidate SCells with a signal quality measurement that exceeds the signal quality threshold. The WTRU may be configured to determine a state for each of the candidate SCells with the signal quality measurement that exceeds the signal quality threshold. The state of the candidate SCells may be either an active state, an inactive state or a dormant state. The signal quality measurement may also exceed the signal quality threshold based on a maximum number of SCells that can be configured by the WTRU. In embodiments, a plurality of the candidate SCells may be associated with the same frequency. The WTRU then applies an SCell configuration for an SCell with the highest signal quality measurement of the plurality of SCells that are associated with the same frequency. Further, the WTRU may send a CHO complete message upon the execution of the CHO to the candidate PCell.

The WTRU may be configured to receive measurement configuration information that indicates triggering conditions associated with the CHO from a serving primary cell (PCell) to a candidate PCell. The candidate PCell may be associated with one or more candidate secondary cells (SCells). The triggering conditions may include a comparison of measurement of signals received from the serving PCell to signals received from the candidate PCell. The triggering conditions may also include measurements associated with the one or more candidate SCells. The WTRU determines whether the first triggering condition is satisfied based on the comparison of the measurement of signals received from the serving PCell to the measurement of signals received from the candidate PCell. The WTRU further determines whether the second triggering condition is satisfied based on measurements associated with the one or more candidate SCells. Once the triggering conditions are both satisfied the WTRU executes the CHO and sends a CHO complete message to the network. In embodiments, the second triggering condition may be based on the average signal level of the serving PCell and SCells, and the average signal level of the target PCell and SCells.

What is claimed is:

1. A wireless transmit receive unit (WTRU) comprising:
a processor configured to:
receive measurement configuration information that indicates:
a list of cells to be measured, wherein the list of cells comprises a serving primary cell (PCell), one or more serving secondary cells (SCells), a candidate PCell, and one or more candidate SCells,
wherein the measurement configuration information comprises a first triggering condition related to at least one of the serving PCell or the candidate PCell, and
a second triggering condition related to at least one of the one or more serving SCells or the one or more candidate SCells;
perform measurements of signals associated with one or more cells included in the list of cells; and determine that the first and second triggering conditions are satisfied; and
send a measurement report based on a determination that the measurement configuration information is not associated with a conditional handover (CHO), wherein the measurement report comprises a layer 1 (L1) or a layer 3 (L3) measurement report.

2. The WTRU of claim 1, wherein the measurement configuration information comprises an indication of whether the measurement configuration information is associated with a measurement reporting configuration or a CHO configuration.

3. The WTRU of claim 1, wherein the processor is configured to:
determine that the first triggering condition is satisfied when a signal quality measurement of the candidate PCell exceeds a first signal quality threshold; and
determine that the second triggering condition is satisfied when a signal quality measurement of at least one of the one or more candidate SCells exceeds a second signal quality threshold.

4. The WTRU of claim 1, wherein the processor is configured to:
determine that the second triggering condition is satisfied when an average signal quality of the one or more candidate SCells exceeds a signal quality threshold.

5. The WTRU of claim 1, wherein the measurement configuration information comprises an indication of a signal quality threshold for the one or more candidate SCells; and
wherein the processor is configured to apply an SCell configuration for each of the one or more candidate SCells with a signal quality measurement that exceeds the signal quality threshold.

6. The WTRU of claim 5, wherein the processor is further configured to determine a state for each of the one or more candidate SCells with the signal quality measurement that exceeds the signal quality threshold, wherein the state is one of an active state, an inactive state, or a dormant state.

7. The WTRU of claim 1, wherein the processor is further configured to:
determine that the measurement configuration information is associated with measurement reporting; and
send the measurement report based on the determination that the measurement configuration information is associated with measurement reporting.

8. The WTRU of claim 1, wherein a plurality of the one or more candidate SCells are associated with a same frequency; and
wherein the processor is configured to apply an SCell configuration for an SCell with the highest signal quality measurement of the plurality of SCells that are associated with the same frequency.

9. The WTRU of claim 1, wherein the processor is further configured to send a CHO complete message upon the execution of the CHO to the candidate PCell.

10. A method for a wireless transmit receive unit (WTRU), the method comprising:
receiving measurement configuration information that indicates:
a list of cells to be measured, wherein the list of cells comprises a serving primary cell (PCell), one or more serving secondary cells (SCells), a candidate PCell, and one or more candidate SCells,
wherein the measurement configuration information comprises a first triggering condition related to at least one of the serving PCell or the candidate PCell, and
a second triggering condition related to at least one of the one or more serving SCells or the one or more candidate SCells;
performing measurements of signals associated with the list of cells;
determining that the first and second triggering conditions are satisfied; and
sending a measurement report based on a determination that the measurement configuration is not associated with a conditional handover (CHO), wherein the measurement report comprises a layer 1 (L1) or a layer 3 (L3) measurement report.

11. The method of claim 10, wherein the measurement configuration information comprises an indication of whether the measurement configuration information is associated with a measurement reporting configuration or a CHO configuration.

12. The method of claim 10, further comprising:
determining whether the first triggering condition is satisfied when a signal quality measurement of the candidate PCell exceeds a first signal quality threshold; and
determining whether the second triggering condition is satisfied when a signal quality measurement of at least one of the one or more candidate SCells exceeds a second signal quality threshold.

13. The method of claim 10, further comprising:
determining whether the second triggering condition is satisfied when an average signal quality of the one or more candidate SCells exceeds a signal quality threshold.

14. The method of claim 10, further comprising:
applying an SCell configuration for each of the one or more candidate SCells with a signal quality measurement that exceeds a signal quality threshold for the one or more candidate SCells, wherein the measurement configuration information comprises an indication of the signal quality threshold.

15. The method of claim 10, further comprising:
determining a state for each of the one or more candidate SCells with the signal quality measurement that exceeds the signal quality threshold, wherein the state is one of an active state, an inactive state, or a dormant state.

16. The method of claim 10, further comprising:
Determining that the measurement configuration information is associated with measurement reporting; and
sending the measurement report based on the determination that the measurement configuration information is associated with measurement reporting.

17. The method of claim 10, further comprising:
applying an SCell configuration for an SCell with the highest signal quality measurement of the plurality of SCells that are associated with a same frequency, wherein a plurality of the one or more candidate SCells are associated with the same frequency.

18. The method of claim 10, further comprising:
sending a CHO complete message upon the execution of the CHO to the candidate PCell.

19. (canceled)

20. (canceled)
